(19) United States
(12) Patent Application Publication
(10) Pub. No.: US 2005/0174349 A1
(43) Pub. Date: Aug. 11, 2005

(54) Image rendering apparatus with print preview projection mechanism

(76) Inventor: Brian S. Watson, Dallas, OR (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/773,895

(22) Filed: Feb. 5, 2004

(51) Int. Cl. G06T 15/10; H04N 1/46; G06F 15/00; G06T 15/20

(52) U.S. Cl. 345/427; 358/500; 358/1.1

(57) ABSTRACT

An apparatus has a rendering engine for rendering images onto a medium (e.g., paper). An input port is provided for receiving image data. A print preview projection mechanism converts the received image data into corresponding displayable image data, and projects the displayable image data (e.g., a preview image) for viewing by a user.

### BACKGROUND OF THE INVENTION

In recent years, there has been a marked increase in the popularity of digital photography. As the resolution of the cameras has increased, while the price of the cameras has decreased, the digital camera has become an affordable must-have consumer electronic gadget. The use of digital cameras is widespread and pervades into all areas of our society. For example, there is hardly a place in society where one can go, where one does not see people with digital cameras. Digital cameras are commonly found in the workplace, in restaurants, in workplaces, in shopping centers, in parks, in schools, campuses and universities, in recreation areas, in virtually every venue of society, where one desires to capture a memory.

The popularity of taking pictures with digital cameras, sharing digital photos electronically, and using software to view, edit and organize digital photos has increased dramatically in the past several years. Creating Web-based photo galleries with these digital photos has also been on the rise. With increases in resolution, memory, and advanced electronics, digital cameras offer pictures that rival picture taken by film-based cameras with the ease and convenience offered by a digital file.

There has also been an increase in the number of devices that can store digital photos. In the past, picture files (e.g., .jpg files) were stored on a disk or hard drive of a desktop computer. Today, the sources of images files are numerous and varied. For example, digital images may be stored in portable devices, such as laptop computers, personal digital assistants, hand-held computers, and digital cameras. Many cellular telephones are now even equipped with a digital camera and can store digital images. Although the digital form of the image or photo can meet many of a user's needs (e.g., for display on a monitor or television), the user may at some time need to generate a hard copy for picture frames or physical photo album, for example.

Unfortunately, the user must undertake a tedious process to get the digital photos printed into a hardcopy. This process can involve the following steps: 1) turn on the desktop computer; 2) connect digital camera to desktop computer system; 3) locate and open a digital photo application program; 4) download the images to the desktop program; 5) view and edit the photos displayed on a computer monitor as necessary; and 6) select print button in the digital photo application program. Users have long complained of this inconvenient and tedious process that is required to preview photos for printing and to send photos to the printer for printing.

One trend is to simplify and increase the number of different ways to download data into the printer. A first way to download data to the printer is the conventional printer cable. A second way is to equip the printer with a memory card reader through which photos stored on a memory card can be directly downloaded to the printer for printing without having to go through a desktop computer. A third way is to provide a USB port so that digital cameras can directly download photos stored therein to the printer for printing without having to go through a desktop computer.

Another trend is to utilize a liquid crystal display (LCD) viewer for viewing photographs sent to printers instead of a computer monitor. The Canon CV-100 image viewer, available from Canon U.S.A., Inc., offers a 1.5-inch LCD screen. The CV-100 image viewer can be attached to the Canon S530D, S820D, and S830D bubble jet printers for viewing photos that are being printed. The Canon i900D photo printer, which is also available from Canon U.S.A., Inc., offers a 2.0-inch LCD that is integrated with the printer. The HP Photosmart 7960 photo printer, which is available from Hewlett-Packard Company, offers a 2.5-inch color LCD that is integrated with the printer. The LCD can be utilized by a user to preview photos.

While these viewers offer improvements over the tedious printing process involving a desktop computer and monitor described previously, these approaches suffer from several disadvantages. One disadvantage stems from the small and limited size of the LCD, which have dimensions that are in the range of 1.5 to 2.5 inches. As many have experienced, viewing photos on a screen of such a size is inconvenient. For example, this small screen size may not always provide a sufficiently detailed representation of the photo on which to base a decision to print the photo. Moreover, using a small screen to select different image viewing functions can feel awkward, foreign, and cramped, thereby leading to selection errors or un-intended results with the attendant frustration and confusion.

The HP Photosmart 7960 photo printer also offers some simple color corrections capabilities (e.g., red-eye reduction). However, with the small LCD monitor, it would seem very difficult to accurately identify those features (e.g., colors) that may need correction or to accurately access whether a change in color is to one's liking after a correction has been made. Consequently, the displayed versions of the photos are often not be suitable for editing purposes because they do not provide sufficient details of the image.

The Epson P-1000 photo viewer, available from Epson America, Inc., is a 10 GB storage unit with a 3.8″ VGA LCD. It is noted that the P-1000 viewer's screen is larger than the screens offered by the Canon CV-100 viewer, Canon i900D printer, and the HP Photosmart 7960 printer. The P-1000 photo viewer with its larger screen is designed to operate primarily as a stand-alone viewer. However, the P-1000 can be connected to select Epson printers to print photos. One disadvantage of this approach, which is also a disadvantage of the Canon CV100, is that a user must expend additional funds to purchase a separate viewer even after the purchase of a printer. Another disadvantage of this approach is that the P-1000 does not appear to offer photo editing capabilities or photo organization capabilities. One would still be required to rely on a computer and computer monitor to perform those operations.

According, it would be desirable to have a printer with a display mechanism that addresses the concerns and shortcomings described above. Furthermore, it would be desirable for the printer to offer additional photo viewing, editing and organizing features and options that would facilitate the printing of digital photos.

Based on the foregoing, there remains a need for an image rendering device with a print preview projection mechanism that overcomes the disadvantages set forth previously.

### SUMMARY OF THE INVENTION

According to one embodiment of the present invention, an apparatus with print preview projection mechanism is described. The apparatus has a rendering engine for rendering images onto a medium (e.g., paper). An input port is provided for receiving an image data (e.g., a file that contains one or more digital pictures). A print preview projection mechanism converts the received image data into corresponding displayable image data and projects the displayable image data (e.g., a preview image) for viewing by a user.

### BRIEF DESCRIPTION OF THE DRAWINGS

The present invention is illustrated by way of example, and not by way of limitation, in the figures of the accompanying drawings and in which like reference numerals refer to similar elements.

FIG. 1 illustrates an apparatus according to one embodiment of the invention that is equipped with a print preview projection mechanism (PPPM) according to one embodiment of the invention.

FIG. 2 illustrates in a block diagram illustrating in greater detail the print preview projection mechanism (PPPM) of FIG. 1 according to one embodiment of the invention.

FIG. 3 is a flowchart illustrating the processing steps performed by the print preview projection mechanism according to one embodiment of the invention.

FIG. 4 is a flowchart illustrating the processing steps performed by the print preview projection mechanism according to an alternative embodiment of the invention.

FIG. 5 is a flowchart illustrating the processing steps performed by an editing mechanism according to one embodiment of the invention.

FIG. 6 is a flowchart illustrating the processing steps performed by a multiple image manipulating mechanism according to one embodiment of the invention.

### DETAILED DESCRIPTION

An apparatus with print preview projection mechanism and related methods are described. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Apparatus 100

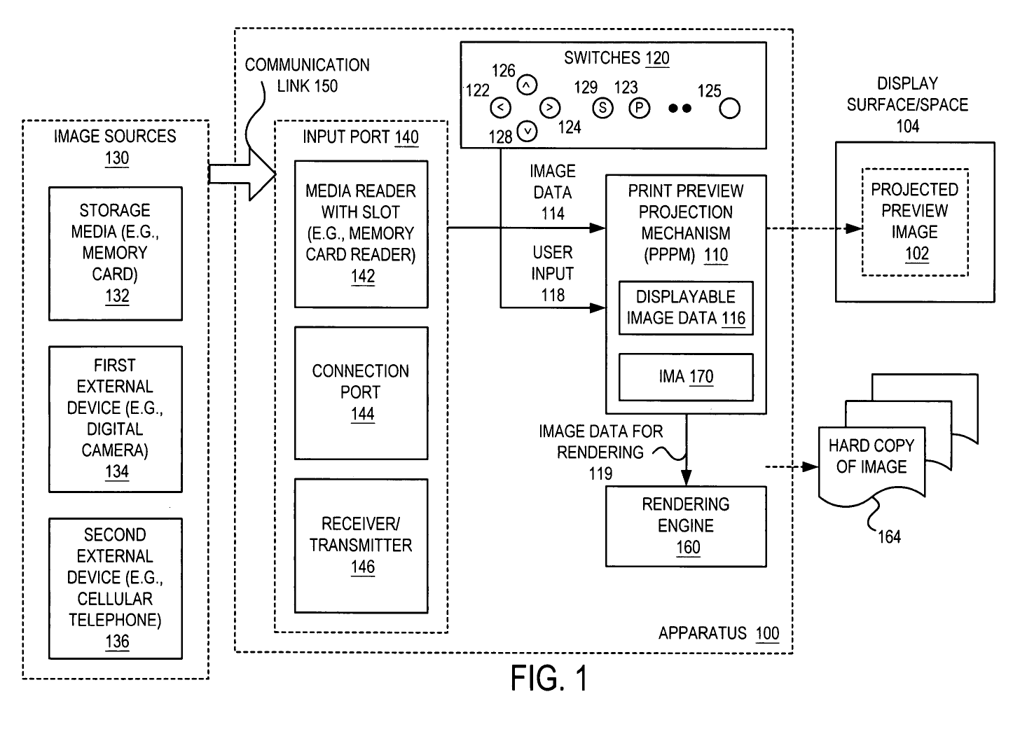

FIG. 1 illustrates an apparatus 100 according to one embodiment of the invention that is equipped with a with print preview projection mechanism (PPPM) 110. For example, apparatus 100 can be, but is not limited to, an image rendering apparatus, a printer (e.g., a laser printer, dot-matrix printer or ink-jet printer), facsimile machine, and an all-in-one office machine. The apparatus 100 includes a rendering engine 160, which is also referred to herein as “print engine 160,” for rendering images onto a medium (e.g., paper) in order to generate a hardcopies of the images.

The rendering engine 160 can include a system controller (e.g., a microcontroller) that is coupled to a system bus for executing programs related to printing functions and an image processor that is also coupled to the system bus for executing image processing programs. The apparatus 100 can also include a memory and a memory controller that handles data communication between the memory and the system bus. The memory can include software applications for performing the image processing, print functions, and operations related to the print preview projection mechanism according to the invention. The memory can also be utilized to store image data, both raw image data downloaded from a source or modified image data (e.g., data modified by image manipulation application 170 as described hereinafter). The construction and operation of the print engine 160 is known by those of ordinary skill in the art and will not be described herein.

The apparatus 100 also includes an input port 140 for receiving image data 114. The input port 140 can be coupled to an image source 130 through a communication link 150. For example, the image source 130 can include a storage media 132 (e.g., a memory card), a first device 134 that is external to the apparatus 100 (“first external device 134”), a second device 136 that is also external to the apparatus 100 (“second external device 136”), or a combination thereof. In one embodiment, the first external device 134 is an image capture device, such as a digital camera, and the second external device 136 is a personal communication device, such as a cellular telephone.

The image data 114 can be transferred from the image source 130 to the input port 140 through the communication link 150. Communication link 150 can include, but is not limited to, a wired link and a wireless link. A wired link can be implemented with a cable (e.g., a USB compliant cable or a custom cable). A wireless link can be implemented by equipping the external devices 134, 136 with a transmitter and by equipping the apparatus 100 with a receiver or transceiver (e.g., receiver 146).

The input port 140 can include a media reader 142, a connection port 144 for coupling to a cable (e.g., a USB cable), a receiver or transceiver 146 for receiving image data in the form of transmitted signals, or a combination thereof. In the first example, the input port 140 includes a media reader 142 (e.g., memory card reader) that receives a removable storage media 132 (e.g., a removable memory card), which can have stored thereon one or more image data files. The media reader 142 has a slot for receiving the storage media 132. The image rendering apparatus 100 can include a media reader interface (reader I/F) for handling data transfer to and from the media reader 142 and a bus interface (bus I/F) for communicating data between the media reader 142 the a system bus. The construction and operation of the media reader 142, media reader interface, and bus interface are known to those of ordinary skill in the art and will not be described in detail herein.

In the second example, the input port 140 includes a connection port 144 (e.g., a USB port) for coupling to external devices 134, 136 (e.g., a digital camera or cellular telephone) that can have stored thereon one or more image data files. The apparatus 100 also includes a connection port interface (connection port I/F) for handling data transfer to and from the connection port 144 and a bus interface (bus I/F) for communicating data between the connection port 144 and a system bus. The construction and operation of the connection port 144, connection port interface, and bus interface are known to those of ordinary skill in the art and will not be described in detail herein.

In yet another example, the input port 140 includes a transceiver 146 for communicating image data between an external device 134, 136 (e.g., a cellular telephone) that can have stored thereon one or more image data files. The apparatus 100 also includes a receiver interface for handling data transfer to and from the transceiver 146 and a bus interface (bus I/F) for communicating data between the transceiver 146 and a system bus. The construction and operation of the receiver interface and bus interface are known to those of ordinary skill in the art and will not be described in detail herein.

The PPPM 110 receives image data 114 from the image source 130, converts the received image data 114 into corresponding displayable image data 116, and projects the displayable image data 116 as a projected preview image (PPI) 102. In one embodiment, the PPPM 110 generates the preview image (e.g., a preview image 102) based on the displayable image data 116.

The print preview projection mechanism (PPPM) 110 according to the invention projects a preview image 102 onto a display surface (e.g., a horizontal surface or a vertical surface) or into a display space (e.g., a three-dimensional space).

For example, the PPPM 110 may project the preview image 102 onto a display surface 104 (e.g., a vertical surface or a horizontal surface) for viewing by a user. When the display 104 is a two-dimensional (2D) surface, the display 104 can be a wall, a projection screen, a surface of the apparatus 100, or other surface. Alternatively, the PPPM 110 can project the preview image 102 into three-dimensional (3D) space. When the display 104 is three-dimensional (3D) space, the preview image 102 can be optically floated in space in front of a user. As described in greater detail hereinafter, the PPPM 110 may also provide a preview image 102 to a viewfinder (e.g., virtual reality glasses or other viewer).

The size of the projected preview image 102 can be a standard size (e.g., 8.5 inches×11 inches) or a custom size. In one embodiment, the projected preview image 102 has a size that is comparable to the size of computer monitors (e.g., a 15-inch monitor, a 17-inch monitor, or a 19-inch monitor).

The apparatus 100 also includes one or more user-operated switches 120 (e.g., front panel switches or buttons) for use by a user to control print preview functions and image editing functions. For example, the switches 120 can be employed by a user to select commands related to print preview and image editing, which are described in greater detail hereinafter. In this example, there is a plurality of user-operated switches 120. The user-operated switches 120 include a left arrow button 122, a right arrow button 124, an up arrow button 126, a down arrow button 128, a select button 129, a print button 123, and other buttons (e.g., button 125). According to one embodiment, each switch, when activated by the user, generates a signal representing user input (e.g., user input 118). The signal 118 is then provided to the print preview projection mechanism 110.

The image data 114 can include, for example, text data, digital picture data, graphic data, drawing data, images, or a combination of one or more of the above types of data. The image data 114 can include one or more images stored in a file or a digital photo album with multiple pages, where each page has a predetermined page format or layout and where each page contains one or more images (e.g., digital photos).

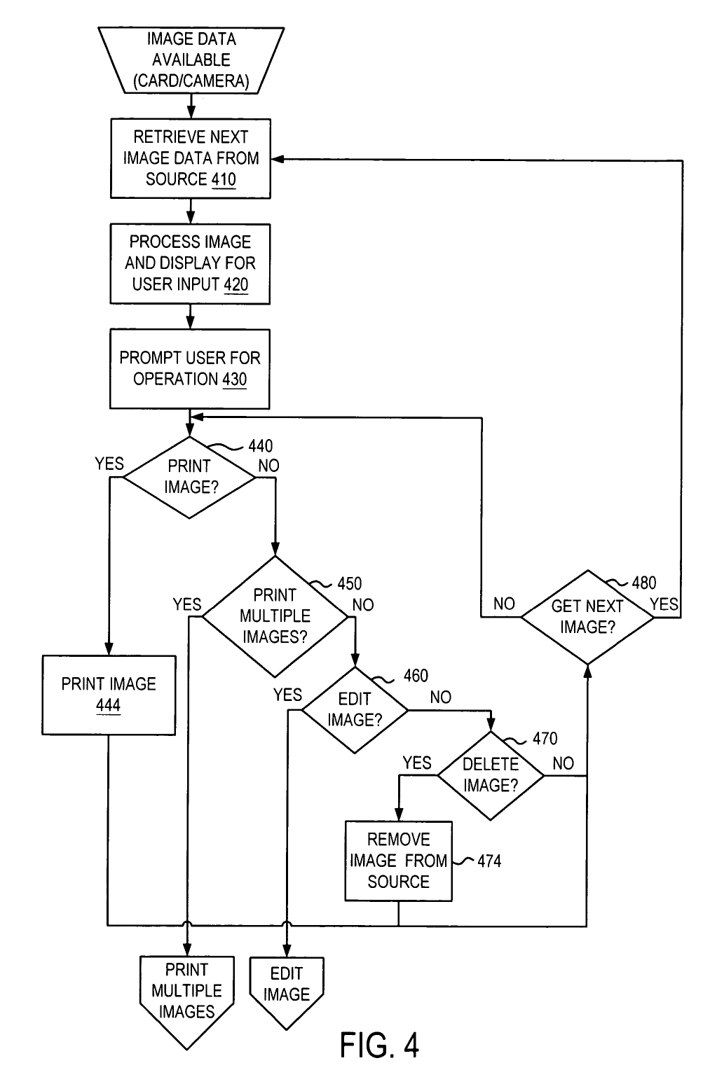

The PPPM 110 can also include an image manipulation application (IMA) 170 that allows a user to manipulate the image data prior to rendering. The IMA 170 can include software modules that support or implement user interface functions, editing operations, compositing operations, image processing operations, delete and add operations, other image modification operations, or a combination thereof. In this manner, the IMA 170 allows a user to perform editing functions, such as removing red-eye, increasing brightness, organizing pictures, selecting a page layout or format, and arranging pictures in the selected page layout (e.g., adding or deleting pictures from a predetermined layout). These functions or operations are described in greater detail with reference to FIGS. 4-6.

Accordingly, the PPPM 110 also receives user input 118 (e.g., input from switches 120) to modify or edit image data (e.g., image data modified by the IMA 170 or composite image data generated by the IMA 170). It is noted that the print preview projection mechanism (PPPM) according to the invention advantageously provides a large preview image with sufficient details (e.g., a preview image with a size that is comparable to standard PC monitors) so that a user can conveniently view, edit, organize, format, and lay-out images, and create digital photo albums of pictures prior to generating a hard copy of those images (e.g., digital photographs) without the inconveniences of the prior art approaches described previously.

Print Preview Projection Mechanism (PPPM)

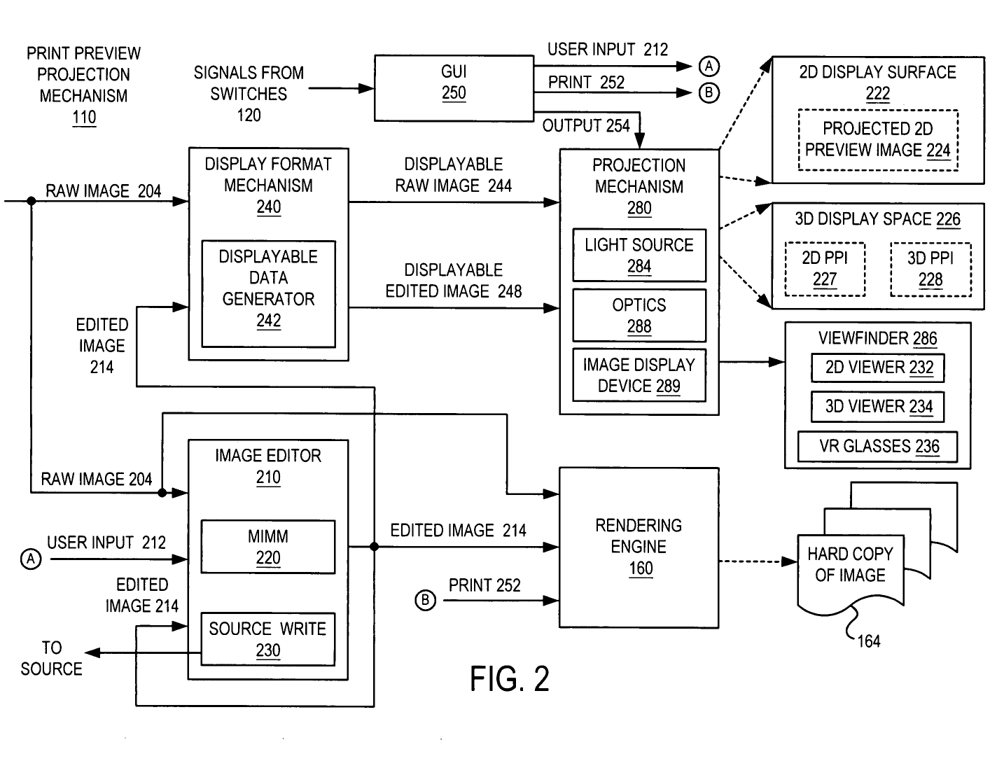

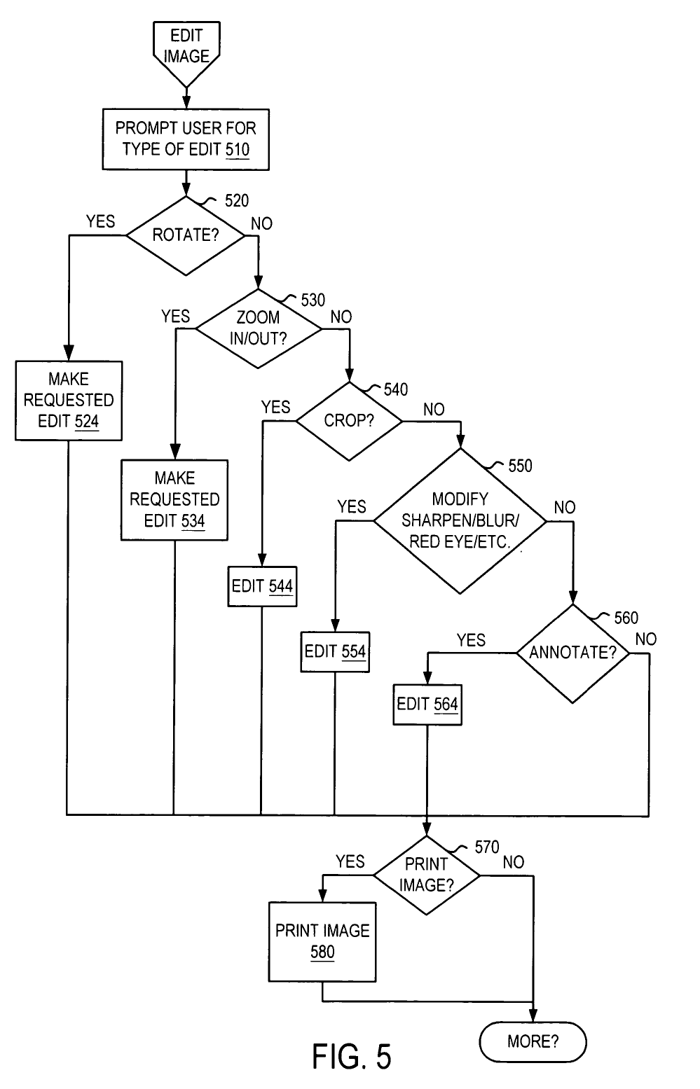

FIG. 2 is a block diagram illustrating in greater detail the print preview projection mechanism (PPPM) 110 of FIG. 1 according to one embodiment of the invention. The PPPM 110 includes an image editor 210 for performing one or more editing operations described in greater detail with reference to FIG. 5. In general, the image editor 210 receives image data (e.g., raw image data 204) and generates modified image data (e.g., edited image 214) based on user input 212.

The PPPM 110 includes a graphical user interface (GUI) for providing output 254 (e.g., icons, written instructions, or visual instructions), for receiving signals from switches 120, and for generating signals, such as user inputs 212 and a print command 252. The output of the GUI 250 may be provided to the projection mechanism 280 for projection or to another display on the apparatus 100 for viewing. It is noted that the image editor 210 can received edited image 214 and make further modifications and revisions based on user input 212.

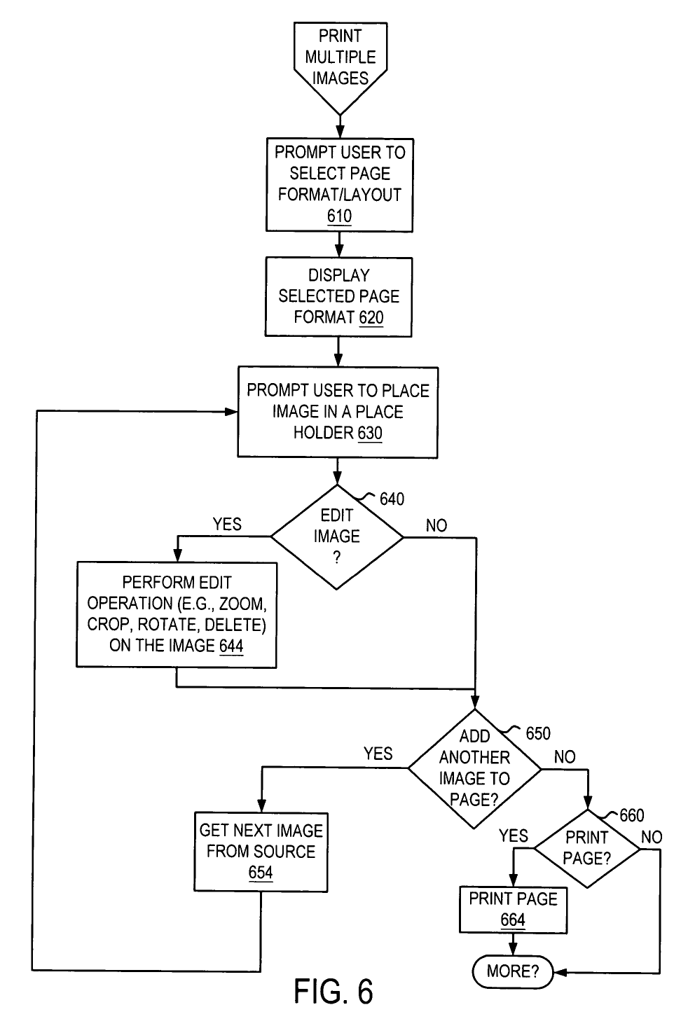

The image editor 210 includes a multiple image manipulation module (MIMM) 220 for performing one or more operations described in greater detail with reference to FIGS. 4 and 6. In general, the multiple image manipulation module (MIMM) 220 receives image data (e.g., two or more images or digital pictures) and generates a composite image file (e.g., a sheet with multiple images or pictures or an electronic photograph album that may have multiple pages of images).

For example, the MIMM 220 can be utilized by a user to select different page layouts for digital photographs. For example, certain layouts may be suited for printing multiple 4×6 photographs, whereas other layouts may be more suited for printing out 3×5 photographs, 5×7 photographs, 8×10 photographs, etc. Once selected, the layouts can be filled with images from the source 130 or edited images 214. In this manner, a user can create pages of images for preview and then printing. The MIMM 220 can also be utilized by the user to add or delete images, image files, different page layouts, or photograph albums.

The image editor 210 also includes a source write unit 230. The MIMM 220 can utilize the source write unit 230 for writing image data to the source 130. For example, the source write unit 230 can write an edited image 214 or a composite image to the source 130.

The PPPM 110 includes a display format mechanism 240 for formatting the received image data into a format acceptable and usable by the projection mechanism 280. The display format mechanism 240 includes a displayable data generator 242 for receiving image data (e.g., raw image data 204 and edited image data 214) and based thereon for generating corresponding displayable data (e.g., displayable raw image data 244 and displayable edited image data 248)), which is suitable for projection or display.

The projection mechanism 280 receives the displayable image data (e.g., 244, 248) and projects or generates a preview image based thereon. The projection mechanism 280 can include a light source 284 and optics 288. In one embodiment, the projection mechanism 280 projects the displayable image data (e.g., 244, 248) onto a two-dimensional (2D) display surface 222, and the projected preview image (PPI) is a two-dimensional (2D) image 224. In another embodiment, the projection mechanism 280 projects the displayable image data (e.g., 244, 248) into three-dimensional (3D) display space 226, and the projected preview image is either a two-dimensional (2D) image 227 or a three-dimensional (3D) image 228.

In one embodiment, the projection mechanism 280 includes an image display device 289 (e.g., a light emitting diode (LED) array, color liquid crystal display (LCD), or plasma display). The image display device 289 optically enlarges the image and projects the “enlarged image” for viewing by the user. In another embodiment, the projection mechanism 280 includes a CRT screen. In yet another embodiment, the projection mechanism 280 can include a slide projector or an overhead projector.

The projection mechanism 280 can be coupled to a viewfinder 286 that a user can wear or look into to view a preview image. The viewfinder 286 can be a two-dimensional (2D) viewer 232, a three-dimensional (3D) viewer 234, or virtual reality (VR) glasses or headgear 236. In one embodiment, when the viewfinder 286 is implemented with the 2D viewer 232 or the 3D viewer 234, the viewer 232, 234 projects a preview image onto the surface of one's eye. In another embodiment, when the viewfinder 286 is implemented with headgear or glasses 236, the VR glasses projects a preview image onto the surface of one's eye.

When a projection mechanism 280 (e.g., a projector) is utilized for projecting the image, the displayable data generator 242 converts the image data (e.g., raw image 204) into a format suitable for the projection mechanism 280. When a viewfinder 286 is utilized for displaying the image to the user, the displayable data generator 242 converts the image data into a format suitable for the viewfinder 286.

Processing Steps

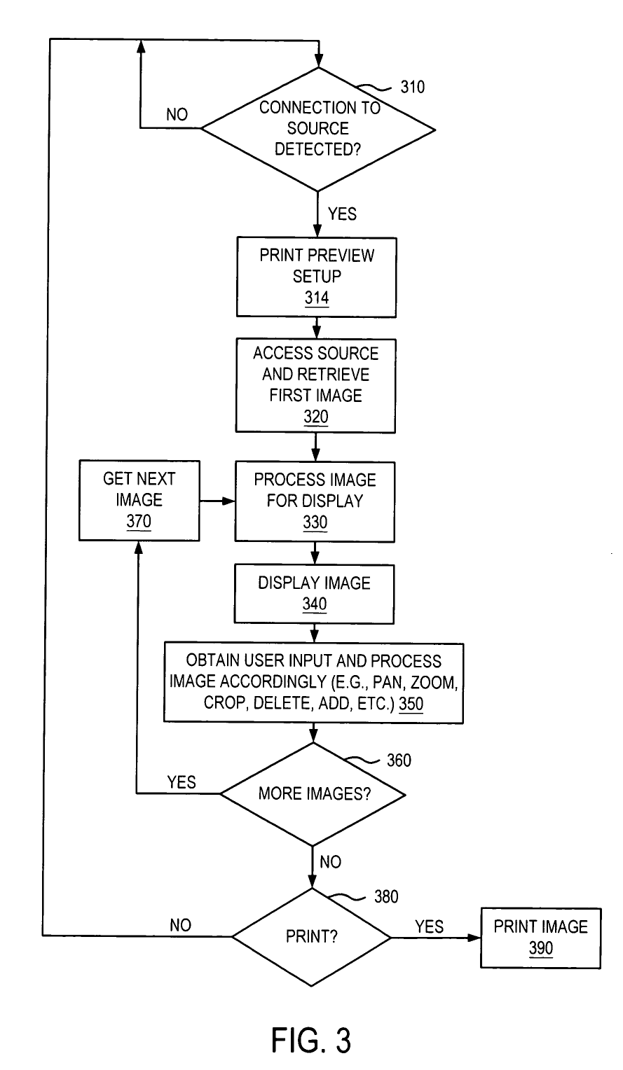

FIG. 3 is a flowchart illustrating the processing steps performed by the print preview projection mechanism (PPPM) according to one embodiment of the invention. In step 310, a determination is made whether a connection with an image source 130 has been detected. For example, this step can determine whether a memory card has been inserted or whether an external device has been connected to the input port 140. When a connection is not detected, the processing remains in step 310. When it is determined that a connection has been detected, the processing proceeds to step 314.

In step 314, print preview set-up is performed. In this step, a user can configure, for example, the options for previewing images, the options for editing the images, the options for compositing the images, and the options for laying out the hard copy of the images.

In step 320, a first image (e.g., a file that contains image data corresponding to a digital picture) is retrieved from the source (e.g., storage media 132 or external devices 134, 136). In step 330, the image data is processed and converted into corresponding displayable image data (e.g., image data in a format that is suitable to be projected or displayed). In step 340, the displayable image data (e.g., image in a displayable format) is sent to a projection mechanism 280 (e.g., projector, viewer, virtual reality head gear or glasses) for projection or display and viewing by the user.

In step 350, one or more user commands are received, and the first image is modified or processed accordingly. For example, a pan operation, a zoom operation, a crop operation, a delete operation, or an add operation may be selected by a user. It is noted that the image manipulation application (IMA) 170 according to the invention can perform processing step 350. These and other user operations are described in greater detail hereinafter with reference to FIGS. 4-6.

In decision block 360, a determination is made whether there are more images to process. When there are no more images to process, the processing proceeds to decision block 380. When there are more images to process, the processing proceeds to processing step 370, where a next image (e.g., another file that contains the next digital picture) is retrieved from the source (e.g., memory card 132 or external device 134, 136). From step 370 processing then proceeds to processing step 330. Steps 330, 340, 350, 360 and 370 are then repeated for each image until there are no more images remaining.

In decision block 380, a determination is made whether a print command has been selected. When a print command has been selected, the processing proceeds to step 390, where the image or group of images are rendered (e.g., printed to generate a hard copy). It is noted that the rendered images may be in the form as provided by the source (e.g., raw image) or may be processed (e.g., edited version of the image). When a print command has not been selected, the processing proceeds to decision block 310, where detection of a memory card connection or external device connection is performed.

Alternative Processing Flow

FIG. 4 is a flowchart illustrating the processing steps performed by the print preview projection mechanism (PPPM) according to an alternative embodiment of the invention. Image data is made available to the apparatus 100 (e.g., printer) from a source 130. For example, data may be made available through the insertion of a memory card in a corresponding slot or through the connection of an external device (e.g., a digital image capture device) to the apparatus 100. In step 410, a next image is retrieved from the source 130.

In step 420, the image data is processed or converted into corresponding displayable image data (e.g., a format that is suitable to be displayed or projected by projection mechanism 280). In step 430, the user is prompted for an operation.

In decision block 440, a determination is made whether a print command has been selected by the user. When a print command has been selected, the image is printed in step 444, and the processing proceeds to decision block 480, which is described hereinafter. When a print command has not been selected, a determination is made whether multiple images are to be printed on a single sheet of paper, for example, in decision block 450.

When the “print multiple images” option has been selected, processing proceeds to step 610 of FIG. 6, which describes the processing for printing multiple images. When the “print multiple images” option has not been selected, a determination is made whether an edit operation has been selected in decision block 460.

When an edit operation has been selected, processing proceeds to step 510 of FIG. 5, which describes the processing for editing images. When an edit operation has not been selected, a determination is made whether a delete image command has been selected in decision block 470.

When a delete operation has been selected, processing proceeds to step 474 where the current image is removed or deleted from the source. It is noted that the image manipulation application (IMA) 170 according to the invention can perform processing steps 440 to 474. When a delete operation has not been selected, a determination is made whether a get next image command has been selected in decision block 480.

When a get next image command has been selected, processing proceeds to step 410, where the next image is retrieved from the source. When a get next image command has not been selected, processing proceeds to decision block 440, where the program waits for user input.

Image Editor Processing

FIG. 5 is a flowchart illustrating the processing steps performed by an editing mechanism according to one embodiment of the invention. For example, steps 510-580 can be performed by the image editor 210 of FIG. 2. In step 510, the user is prompted to select a type of editing function. In decision block 520, a determination is made whether a rotate operation has been selected.

When a rotate operation has been selected, in step 524, the requested edit operation is performed. In this case, the image is rotated by a predetermined number of degrees (e.g., 90 degrees). When a rotate operation has not been selected, in decision block 530, a determination is made whether a zoom in/zoom out operation has been selected.

When a zoom in/zoom out operation has been selected, in step 534, the zoom in/zoom out operation is performed on the image. When the zoom in/zoom out operation has not been selected, in decision block 540, a determination is made whether a crop operation has been selected.

When a crop operation has been selected, in step 544, the crop operation is performed on the image. When a crop operation has not been selected, in decision block 550, a determination is made whether a modify operation (e.g., sharpen, blur, red eye removal, etc.) has been selected.

When a modify operation has been selected, in step 554, the requested modify operation is performed. For example, a sharpen operation, a blur operation, or a red-eye removal operation can be performed on the image. When a modify operation has not been selected, in decision block 560, a determination is made whether an annotate operation has been selected.

When an annotate operation has been selected, in step 564, the annotate operation is performed on the image. When an annotate operation has not been selected, processing proceeds to decision block 570, where a determination is made whether a print command has been selected.

When a print command has been selected, the image is printed in step 580. Otherwise, the program waits for further user input for performing other editing operations, image processing, or multiple image processing. For example, processing can loop back to decision block 440 of FIG. 4, where additional user inputs are processed.

It is noted that other editing functions or image processing functions that are known to those of ordinary skill in the art can be incorporated into this processing flow.

Multiple Image Manipulation Processing

FIG. 6 is a flowchart illustrating the processing steps performed by a multiple image manipulating mechanism according to one embodiment of the invention. For example, steps 610-664 can be performed by MIMM 220 of FIG. 2. In step 610, the user is prompted to select a type of page format or page layout. In step 610, a choice of different types of page formats and layouts can first be presented to a user. In step 620, the selected page format is displayed. In step 630, the user is prompted to place a current image into one of the placeholders provided by the page format or layout (e.g., a selected placeholder).

In decision block 640, a determination is made whether an edit command has been selected. For example, a user can select an edit operation (e.g., zoom, crop, rotate, delete, etc.). When an edit command has been selected, the edit operation is performed in step 644. The edit operation processes the image in response to user commands as described previously with respect to FIG. 5. When an edit command has not been selected, in decision block 650, a determination is made whether another image is to be added to the current page.

When another image is to be added, in step 654, the next image is obtained from the source (e.g., memory card or external device). When another image is not to be added, processing proceeds to decision block 660, where a determination is made whether a print command has been selected.

When a print command has been selected, the page is printed in step 664. Otherwise, the program waits for further user input for performing other editing operations, image processing, or multiple image processing. For example, processing can loop back to decision block 440 of FIG. 4, where additional user inputs are processed.

In the foregoing specification, the invention has been described with reference to specific embodiments thereof. It will, however, be evident that various modifications and changes may be made thereto without departing from the broader scope of the invention. The specification and drawings are, accordingly, to be regarded in an illustrative rather than a restrictive sense.

1. An apparatus comprising:
a) a rendering engine for rendering images onto a medium;
b) an input port for receiving an image data; and
c) a print preview projection mechanism for converting the received image data into corresponding displayable image data and for projecting the displayable image data for viewing by a user.

2. The apparatus of claim 1 wherein the print preview projection mechanism provides the user with a preview of the image data prior to rendering of the image data; and wherein the print preview projection mechanism includes a display format mechanism for converting the received image data into corresponding displayable image data.

3. The apparatus of claim 1 wherein the print preview projection mechanism includes a projection mechanism for projecting the displayable image data onto a two-dimensional surface; and wherein the projected preview image is a two-dimensional image.

4. The apparatus of claim 1 wherein the print preview projection mechanism includes a projection mechanism for projecting the displayable image data into a three-dimensional space; and wherein the projected preview image is one of a two-dimensional image and a three-dimensional image.

5. The apparatus of claim 1 wherein the print preview projection mechanism further includes
an image manipulation application for allowing a user to manipulate the image data prior to rendering.

6. The apparatus of claim 5 wherein the image manipulation application supports one of user interface functions, editing operations, compositing operations, image processing operations, delete and add operations, other image modification operations, and a combination thereof.

7. The apparatus of claim 1 wherein the input port includes one of a connection port, a media reader slot, and a receiver.

8. The apparatus of claim 1 wherein the apparatus is coupled to an image source through a communication link; and wherein the image source provides the image data;
wherein the image source includes one of a storage media, an image capture device, a digital camera, a personal communication device, a cellular telephone, a personal digital assistant, and other device external to the image rendering apparatus; and
wherein the communication link includes one of a wireless link, a wired link, a USB cable, and a channel specified by a predetermined frequency.

9. The apparatus of claim 1 wherein the image data includes one of text data, a digital picture data, graphic data, drawing data, images, and a combination thereof.

10. The apparatus of claim 1 wherein the apparatus is one of a printer, a facsimile machine, and an all-in-one office machine.

11. The apparatus of claim 1 further comprising:
a plurality of switches for use by a user to control print preview functions and image editing functions; wherein each switch, when activated by the user, generates a signal representing user input; and wherein the signal is provided to the print preview projection mechanism.

12. The apparatus of claim 5 wherein the image manipulation application includes
a multiple image manipulation module for receiving image data and user input and based thereon for generating a composite image file; a source write unit for writing data to an image source.

13. An apparatus comprising:
a) a rendering engine for rendering images;
b) an input port for receiving an image data;
c) a display format mechanism for converting the received image data into corresponding displayable image data;
d) a view finder for use by a user to view images; and
e) a projection mechanism, coupled to the viewfinder, for projecting the displayable image data into the viewfinder.

14. The apparatus of claim 13 wherein the viewfinder is one of integrated with the image rendering apparatus and detachable from the image rendering apparatus.

15. The apparatus of claim 13 wherein the viewfinder is coupled to the projection mechanism through one of a wired link and a wireless link.

16. The apparatus of claim 13 wherein the viewfinder is implemented as one of a pair of virtual reality glasses, a two-dimensional viewer, and a three-dimensional viewer; and wherein the projected image is one of projected onto a two-dimensional surface and projected into a three-dimensional space for viewing.

17. The apparatus of claim 13 wherein the image rendering apparatus is one of a printer, a facsimile machine, and an all-in-one office machine.

18. The apparatus of claim 13 further comprising:
an image manipulation application for allowing a user to manipulate the image data prior to rendering; wherein the image manipulation application supports one of user interface functions, editing operations, compositing operations, image processing operations, delete and add operations, other image modification operations, and a combination thereof.
